(19) United States
(12) Patent Application Publication
(10) Pub. No.: US 2015/0350955 A1
(43) Pub. Date: Dec. 3, 2015

(54) TECHNIQUES FOR HANDLING PARTIAL LOADING OF CARRIERS IN WIRELESS COMMUNICATIONS

(71) Applicant: QUALCOMM Incorporated, San Diego, CA (US)

(72) Inventors: Kiran Kumar SOMASUNDARAM, San Diego, CA (US); Vikas JAIN, San Diego, CA (US); Tao LUO, San Diego, CA (US); Hao XU, San Diego, CA (US); Aleksandar DAMNJANOVIC, Del Mar, CA (US); Madhavan Srinivasan VAJAPEYAM, San Diego, CA (US)

(21) Appl. No.: 14/723,289

(22) Filed: May 27, 2015

Related U.S. Application Data
(60) Provisional application No. 62/004,047, filed on May 28, 2014.

(51) Int. Cl. H04W 28/20; H04W 76/04; H04W 72/12

(52) U.S. Cl. CPC H04W 28/20; H04W 72/1263; H04W 76/046

(57) ABSTRACT

Aspects described herein relate to scheduling data for transmission over a plurality of component carriers. A base station can determine to increase bandwidth utilization over at least one component carrier of a plurality of component carriers assigned to a plurality of user equipments (UE). The base station can assign a plurality of resource blocks over the at least one component carrier to one or more fictitious UE identifiers and transmit data signals over the plurality of resource blocks to increase bandwidth utilization over the at least one component carrier. One or more network nodes may determine the one or more fictitious UE identifiers and may determine related resource assignment for canceling interference from data transmitted for the fictitious UE identifiers, performing channel estimation, etc.

### CLAIM OF PRIORITY UNDER 35 U.S.C. §119

The present application for patent claims priority to Provisional Application No. 62/004,047 entitled “TECHNIQUES FOR HANDLING PARTIAL LOADING OF CARRIERS IN WIRELESS COMMUNICATIONS” filed May 28, 2014, which is assigned to the assignee hereof and hereby expressly incorporated in its entirety by reference herein.

### BACKGROUND

Aspects described herein, for example, relate to wireless communication systems, and more particularly to techniques for scheduling data over component carriers having bandwidth requirements in wireless communications.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations (e.g., eNodeBs) that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

To improve the performance of wireless communications, it may be desirable to allow a UE to simultaneously communicate with one or more cells over multiple uplink grants from the cells, which can be referred to as carrier aggregation. The UE may thus utilize one or more carriers to communicate with each of the multiple cells. A primary cell can configure the UE to receive communications from the multiple cells over corresponding component carriers. At least one of the component carriers may utilize bandwidth in an unlicensed frequency spectrum that may be subject to certain requirements. For example, where the base station configures a component carrier in the 5.8 gigahertz (GHz) space for communicating using a mobile network technology, the component carrier may then be subject to regulatory requirements defined for the space. An example of the regulatory requirements can include requirements such as communications in 5.8 GHz must occupy at least 80% of the nominal bandwidth. In some configurations, however, the base station may not communicate enough data over the component carrier to satisfy one or more regulatory requirements for bandwidth utilization.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for scheduling data for transmission over a plurality of component carriers is provided. The method includes determining to increase bandwidth utilization over at least one component carrier of a plurality of component carriers assigned to a plurality of user equipments (UE), assigning a plurality of resource blocks over the at least one component carrier to one or more fictitious UE identifiers, and transmitting data signals over the plurality of resource blocks to increase bandwidth utilization over the at least one component carrier.

In another example, an apparatus for scheduling data for transmission over a plurality of component carriers is provided. The apparatus includes a bandwidth increasing component configured to determine to increase bandwidth utilization over at least one component carrier of a plurality of component carriers assigned to a plurality of UEs, a communication scheduling component configured to assign a plurality of resource blocks over the at least one component carrier to one or more fictitious UE identifiers, and a communicating component configured to transmit data signals over the plurality of resource blocks to increase bandwidth utilization over the at least one component carrier.

In yet another example, an apparatus for scheduling data for transmission over a plurality of component carriers is provided. The apparatus includes means for determining to increase bandwidth utilization over at least one component carrier of a plurality of component carriers assigned to a plurality of UEs, means for assigning a plurality of resource blocks over the at least one component carrier to one or more fictitious UE identifiers, means for transmitting data signals over the plurality of resource blocks to increase bandwidth utilization over the at least one component carrier.

In another example, a computer-readable storage medium storing computer executable code for scheduling data for transmission over a plurality of component carriers is provided. The code includes code for determining to increase bandwidth utilization over at least one component carrier of a plurality of component carriers assigned to a plurality of UEs, code for assigning a plurality of resource blocks over the at least one component carrier to one or more fictitious UE identifiers, and code for transmitting data signals over the plurality of resource blocks to increase bandwidth utilization over the at least one component carrier.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a block diagram conceptually illustrating an example of a wireless communications system, in accordance with aspects described herein.

FIG. 2 is a block diagram conceptually illustrating examples of an eNodeB and a UE configured in accordance with aspects described herein.

FIG. 3 is a block diagram conceptually illustrating an aggregation of radio access technologies at a UE, in accordance with aspects described herein.

FIG. 4 is a block diagram conceptually illustrating an example of data paths between a user equipment (UE) and a packet data network (PDN) in accordance with aspects described herein.

FIG. 5 is a diagram conceptually illustrating multiple connectivity carrier aggregation in accordance with aspects described herein.

FIG. 6 is a block diagram conceptually illustrating an example of an evolved Node B and components configured in accordance with aspects described herein.

FIG. 7 is a flowchart illustrating an example method for scheduling data over multiple component carriers.

FIG. 8 is a flowchart illustrating an example method for increasing bandwidth utilized by one or more component carriers.

FIG. 9 is a flowchart illustrating an example method for canceling interference caused by data transmissions for fictitious UE identifiers.

FIG. 10 is a block diagram conceptually illustrating an example hardware implementation for an apparatus employing a processing system configured in accordance with aspects described herein.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details.

Various methods, apparatuses, devices, and systems are described for handling partial loading of component carriers (CC) in wireless communications. Some CCs established between a wireless device (e.g., a user equipment (UE)) and one or more cells may be over a frequency band that is subject to certain requirements regarding bandwidth utilization over the frequency band. For example, communications in the 5.8 gigahertz (GHz) band may be required to have at least a threshold bandwidth utilization (e.g., 80%). In this regard, a base station that configures the CCs for the UE can determine whether to increase bandwidth utilization over a CC with the UE to comply with regulatory requirements or whether to restrict scheduling data to relinquish the CC with the UE where such requirements cannot be met. In an example, the base station can make this determination based at least in part on a computed level of bandwidth utilization. The base station can compute the bandwidth utilization, for example, based on determining a utilization of resource blocks for data scheduled on the CC, and/or determining a queue length for a radio bearer corresponding to data to be scheduled on the CC, etc.

In another example, where the base station determines to increase the bandwidth utilization over the CC, the base station may load unassigned resource blocks (RBs) with fictitious cell radio network temporary identifier (C-RNTI) assignments to achieve a threshold bandwidth utilization. In an example, the base station may also signal the C-RNTI(s) used to fill the bandwidth, and/or may use the lowest modulation and coding scheme (MCS) to facilitate cancelation of the unassigned resource blocks by unintended receivers (e.g., neighboring cells, UEs, or other network nodes). In other examples, where the base station determines to increase the bandwidth utilization, the base station may reduce an MCS of the scheduled transmission over the CC to achieve at least a threshold bandwidth utilization for the scheduled transmission. In yet another example, where the base station determines to increase the bandwidth utilization, for example, the base station may spread out the RB allocation for a scheduled transmission to occupy at least a threshold bandwidth utilization.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of UMTS. 3GPP LTE and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

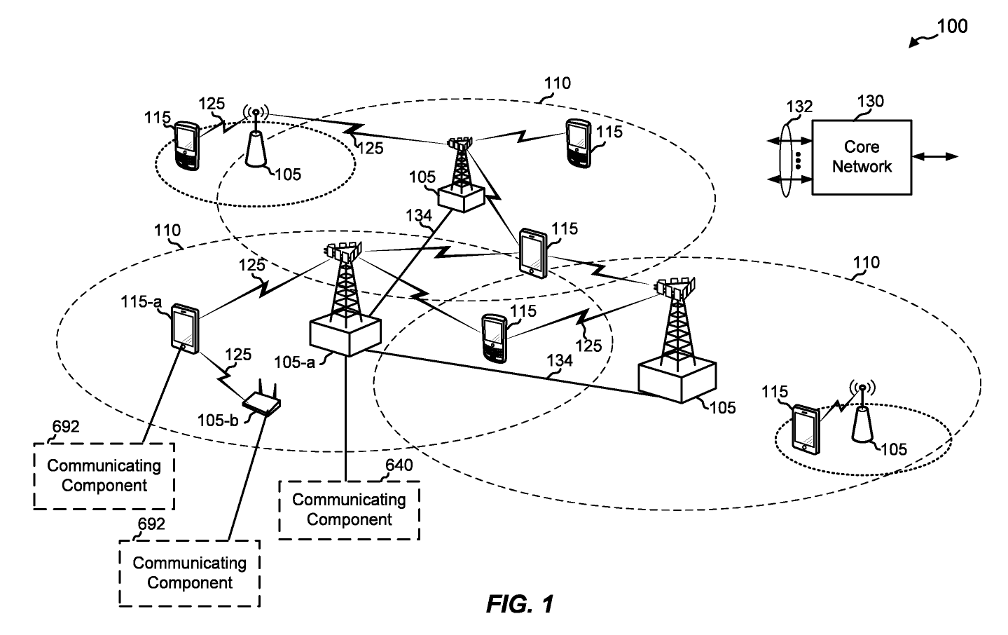

FIG. 1 is a block diagram conceptually illustrating an example of a wireless communications system 100, in accordance with aspects described herein. The wireless communications system 100 includes base stations (or cells) 105, user equipment (UEs) 115, and a core network 130. One or more base stations 105 can include a communicating component 640, as described herein, for scheduling data transmissions to one or more UEs 115 over resources of one or more CCs such to ensure that at least a threshold bandwidth utilization is achieved over at least one of the CCs or the CC otherwise may not be utilized. UE 115 and/or one or more base stations 105 may include a communicating component 692, as described herein, for determining a portion of resources of at least one CC related to transmissions for a fictitious UE identifier and performing one or more operations based on the portion of resources (e.g., canceling interference, performing channel estimation, etc.). The base stations 105 may communicate with the UEs 115 under the control of a base station controller (not shown), which may be part of the core network 130 or the base stations 105 in various embodiments, in one or more cells provided by the base stations 105. The base stations 105 may communicate control information and/or user data with the core network 130 through first backhaul links 132. In embodiments, the base stations 105 may communicate, either directly or indirectly, with each other over second backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc. The wireless communications system 100 may also support operation on multiple flows at the same time. In some aspects, the multiple flows may correspond to multiple wireless wide area networks (WWANs) or cellular flows. In other aspects, the multiple flows may correspond to a combination of WWANs or cellular flows and wireless local area networks (WLANs) or Wi-Fi flows.

The base stations 105 may wirelessly communicate with the UEs 115 via one or more base station antennas. Each of the base stations 105 sites may provide communication coverage for a respective geographic coverage area 110. In some embodiments, base stations 105 may be referred to as a base transceiver station, a radio base station, an access point, a radio transceiver, a basic service set (BSS), an extended service set (ESS), a NodeB, eNodeB, Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro, micro, and/or pico base stations). There may be overlapping coverage areas for different technologies.

In implementations, the wireless communications system 100 is an LTE/LTE-A network communication system. In LTE/LTE-A network communication systems, the terms evolved Node B (eNodeB) may be generally used to describe the base stations 105. The wireless communications system 100 may be a Heterogeneous LTE/LTE-A network in which different types of eNodeBs provide coverage for various geographical regions. For example, each eNodeB 105 may provide communication coverage for a macro cell, a pico cell, a femto cell, and/or other types of cell. A macro cell generally covers a relatively large geographic area (e.g., several kilometers in radius) and may allow unrestricted access by UEs 115 with service subscriptions with the network provider. A pico cell would generally cover a relatively smaller geographic area (e.g., buildings) and may allow unrestricted access by UEs 115 with service subscriptions with the network provider. A femto cell would also generally cover a relatively small geographic area (e.g., a home) and, in addition to unrestricted access, may also provide restricted access by UEs 115 having an association with the femto cell (e.g., UEs 115 in a closed subscriber group (CSG), UEs 115 for users in the home, and the like). An eNodeB 105 for a macro cell may be referred to as a macro eNodeB. An eNodeB 105 for a pico cell may be referred to as a pico eNodeB. And, an eNodeB 105 for a femto cell may be referred to as a femto eNodeB or a home eNodeB. An eNodeB 105 may support one or multiple (e.g., two, three, four, and the like) cells. The wireless communications system 100 may support use of LTE and WLAN or Wi-Fi by one or more of the UEs 115.

The core network 130 may communicate with the eNodeBs 105 or other base stations 105 via first backhaul links 132 (e.g., S1 interface, etc.). The eNodeBs 105 may also communicate with one another, e.g., directly or indirectly via second backhaul links 134 (e.g., X2 interface, etc.) and/or via the first backhaul links 132 (e.g., through core network 130). The wireless communications system 100 may support synchronous or asynchronous operation. For synchronous operation, the eNodeBs 105 may have similar frame timing, and transmissions from different eNodeBs 105 may be approximately aligned in time. For asynchronous operation, the eNodeBs 105 may have different frame timing, and transmissions from different eNodeBs 105 may not be aligned in time. The techniques described herein may be used for either synchronous or asynchronous operations.

The UEs 115 may be dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with macro eNodeBs, pico eNodeBs, femto eNodeBs, relays, and the like.

The communication links 125 shown in the wireless communications system 100 may include uplink (UL) transmissions from a UE 115 to an eNodeB 105, and/or downlink (DL) transmissions, from an eNodeB 105 to a UE 115. The downlink transmissions may also be called forward link transmissions while the uplink transmissions may also be called reverse link transmissions.

In certain aspects of the wireless communications system 100, a UE 115 may be configured to support carrier aggregation (CA) with one or more cells, where each cell can be provided by one or more eNodeBs 105. The eNodeBs 105 that are used for carrier aggregation may be the same eNodeB 105 (e.g., where the multiple cells correspond to the same eNodeB 105), may be collocated, or may be connected through fast connections. In any case, coordinating the aggregation of CCs for wireless communications between the UE 115 and the eNodeB(s) 105 may be carried out more easily because information can be readily shared between the various cells being used to perform the carrier aggregation. In an example, the UE 115 can communicate with a primary cell (PCell) that provides a primary CC (PCC), and/or at least one secondary cell (SCell) that provides a secondary CC (SCC). In some configurations, the PCell may provide one or more SCCs in addition or alternatively to the SCC. In an example, the PCell may control configuration of the PCC and SCC to the UE 115. When the eNodeBs 105 that are used for carrier aggregation are non-collocated (e.g., far apart or do not have a high-speed connection between them), then coordinating the aggregation of CCs may involve additional aspects.

In some implementations, carrier aggregation can be extended to multiple connectivity (e.g., UE 115 connected to two or more non-collocated eNodeBs 105), such that the UE 115 may receive configuration information to communicate with a first eNodeB 105 (e.g., SeNodeB or SeNB) through a primary cell of the first eNodeB 105. The first eNodeB 105 may include a group of cells referred to as a secondary cell group (SCG), which includes one or more secondary cells and the primary cell or PCell_{SCG} of the first eNodeB 105. The UE 115 may also receive configuration information to communicate with a second eNodeB 105 (e.g., MeNodeB or MeNB) through a second primary cell of the second eNodeB 105. The second eNodeB 105 may include a group of cells referred to as a master cell group (MCG), which includes one or more secondary cells and the primary cell or PCell of the second eNodeB 105.

In certain aspects of the wireless communications system 100, carrier aggregation for multiple connectivity may involve having a secondary eNodeB 105 (e.g., SeNodeB or SeNB) be configured to operate one of its cells as a PCell_{SCG}. The secondary eNodeB 105 may transmit, to a UE 115, configuration information through the PCell_{SCG} for the UE 115 to communicate with the secondary eNodeB 105 while the UE 115 is in communication with a master eNodeB 105 (e.g., MeNodeB or MeNB). The master eNodeB 105 may transmit, to the same UE 115, configuration information via its PCell for that UE 115 to communicate with the other eNodeB 105. The two eNodeBs 105 may be non-collocated, in this example.

In examples described herein, a UE 115 may be configured with at least two CCs with one or more eNodeBs—a PCC and an SCC. The PCC and/or the SCC can be configured in a frequency space having regulatory requirements, such as the 5.8 GHz space which can require a certain level of bandwidth utilization (e.g., 80%). To comply with the bandwidth utilization, at least one of the eNodeBs providing the PCC and/or SCC may attempt to achieve the level of bandwidth utilization, which may include computing a utilization by communications for the UE over the PCC and/or SCC and determining whether to increase bandwidth utilization over the PCC and/or SCC to comply with the utilization requirements or whether to restrict scheduling of data such to relinquish the PCC and/or SCC where the level of bandwidth utilization may not be achieved.

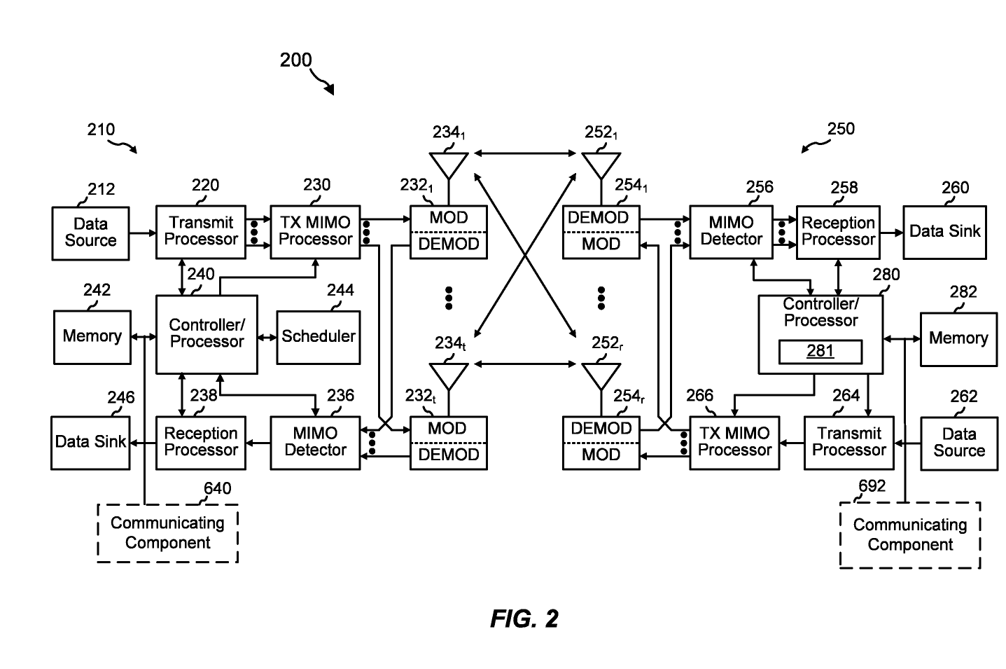

FIG. 2 is a block diagram conceptually illustrating examples of an eNodeB 210 and a UE 250 configured in accordance with an aspect of the present disclosure. For example, the eNodeB 210 (or base station) and the UE 250 of a system 200, as shown in FIG. 2, may be one of the base stations/eNodeBs 105 and one of the UEs 115 in FIG. 1, respectively. Thus, for example, eNodeB 210 can include a communicating component 640, as described herein, for scheduling data transmissions to one or more UEs 250 over resources of one or more CCs such to ensure that at least a threshold bandwidth utilization is achieved over at least one of the CCs or the CC otherwise may not be utilized. In addition, UE 250 may include a communicating component 692, as described herein, for determining a portion of resources of at least one CC related to transmissions for a fictitious UE identifier by eNodeB 210 and performing one or more operations based on the portion of resources (e.g., canceling interference, performing channel estimation, etc.). In some aspects, the eNodeB 210 may support carrier aggregation and/or multiple connectivity. The eNodeB 210 may be a MeNodeB or MeNB having one of the cells in its MCG configured as a PCell or an SeNodeB or SeNB having one of its cells in its SCG configured as a PCell_{SCG}. The UE 250 may receive configuration information from the eNodeB 210 via the PCell and/or the PCell_{SCG}. The eNodeB 210 may be equipped with antennas 234₁₋ₜ, and the UE 250 may be equipped with antennas 252₁₋ᵣ, wherein t and r are integers greater than or equal to one.

At the eNodeB 210, a base station transmit processor 220 may receive data from a base station data source 212 and control information from a base station controller/processor 240. The control information may be carried on the PBCH, PCFICH, physical hybrid automatic repeat/request (HARQ) indicator channel (PHICH), physical downlink control channel (PDCCH), etc. The data may be carried on the physical downlink shared channel (PDSCH), etc. The base station transmit processor 220 may process (e.g., encode and symbol map) the data and control information to obtain data symbols and control symbols, respectively. The base station transmit processor 220 may also generate reference symbols, e.g., for the PSS, SSS, and cell-specific reference signal (RS). A base station transmit (TX) multiple-input multiple-output (MIMO) processor 230 may perform spatial processing (e.g., precoding) on the data symbols, the control symbols, and/or the reference symbols, if applicable, and may provide output symbol streams to the base station modulators/demodulators (MODs/DEMODs) 232₁₋ₜ. Each base station modulator/demodulator 232 may process a respective output symbol stream (e.g., for OFDM, etc.) to obtain an output sample stream. Each base station modulator/demodulator 232 may further process (e.g., convert to analog, amplify, filter, and upconvert) the output sample stream to obtain a downlink signal. Downlink signals from modulators/demodulators 232₁₋ₜ may be transmitted via the antennas 234₁₋ₜ, respectively.

At the UE 250, the UE antennas 252₁, may receive the downlink signals from the eNodeB 210 and may provide received signals to the UE modulators/demodulators (MODs/DEMODs) 254₁₋ᵣ, respectively. Each UE modulator/demodulator 254 may condition (e.g., filter, amplify, downconvert, and digitize) a respective received signal to obtain input samples. Each UE modulator/demodulator 254 may further process the input samples (e.g., for OFDM, etc.) to obtain received symbols. A UE MIMO detector 256 may obtain received symbols from all the UE modulators/demodulators 254₁₋ᵣ, and perform MIMO detection on the received symbols if applicable, and provide detected symbols. A UE reception processor 258 may process (e.g., demodulate, deinterleave, and decode) the detected symbols, provide decoded data for the UE 250 to a UE data sink 260, and provide decoded control information to a UE controller/processor 280.

On the uplink, at the UE 250, a UE transmit processor 264 may receive and process data (e.g., for the PUSCH) from a UE data source 262 and control information (e.g., for the PUCCH) from the UE controller/processor 280. The UE transmit processor 264 may also generate reference symbols for a reference signal. The symbols from the UE transmit processor 264 may be precoded by a UE TX MIMO processor 266 if applicable, further processed by the UE modulator/demodulators 254₁₋ᵣ (e.g., for SC-FDM, etc.), and transmitted to the eNodeB 210. At the eNodeB 210, the uplink signals from the UE 250 may be received by the base station antennas 234, processed by the base station modulators/demodulators 232, detected by a base station MIMO detector 236 if applicable, and further processed by a base station reception processor 238 to obtain decoded data and control information sent by the UE 250. The base station reception processor 238 may provide the decoded data to a base station data sink 246 and the decoded control information to the base station controller/processor 240.

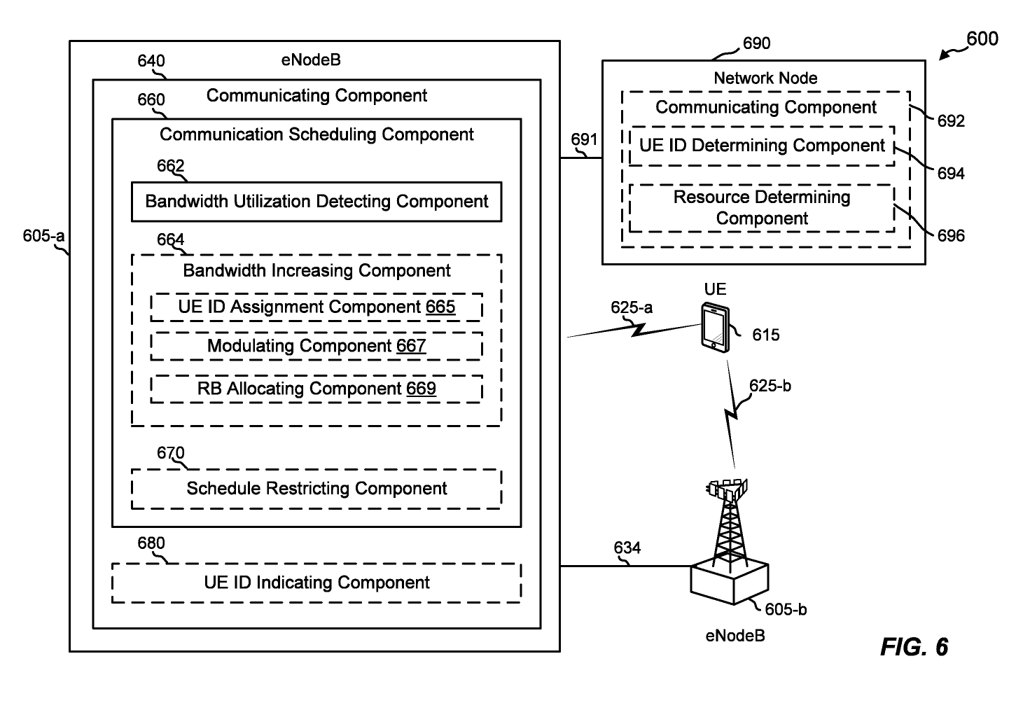

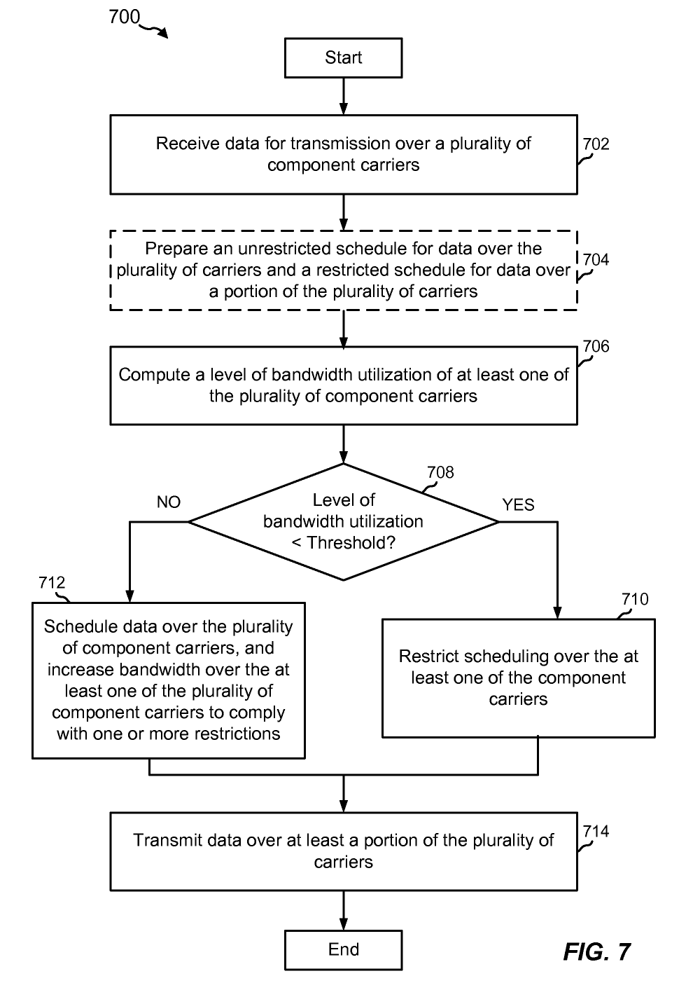

The base station controller/processor 240 and the UE controller/processor 280 may direct the operation at the eNodeB 210 and the UE 250, respectively. The UE controller/processor 280 and/or other processors and modules at the UE 250 may also perform or direct, e.g., the execution of the functional blocks illustrated in FIG. 6, and/or other processes for the techniques described herein (e.g., flowcharts illustrated in FIGS. 7-9). In some aspects, at least a portion of the execution of these functional blocks and/or processes may be performed by block 281 in the UE controller/processor 280. The base station memory 242 and the UE memory 282 may store data and program codes for the eNodeB 210 and the UE 250, respectively. For example, the UE memory 282 may store configuration information for carrier aggregation and/or multiple connectivity provided by the eNodeB 210 and/or another base station. A scheduler 244 may be used to schedule UE 250 for data transmission on the downlink and/or uplink.

In one configuration, the eNodeB 210 may include means for determining to increase bandwidth utilization over at least one component carrier of a plurality of component carriers assigned to a plurality of UEs. The eNodeB 210 may also include means for assigning a plurality of resource blocks over the at least one component carrier to one or more fictitious UE identifiers. The eNodeB 210 may further include means for transmitting data signals over the plurality of resource blocks to increase bandwidth utilization over the at least one component carrier. In one aspect, the aforementioned means may be the controller/processor 240, the memory 242, the transmit processor 270, the transmit MIMO processor 230, the modulators/demodulators 232, and the antennas 234 configured to perform the functions recited by the aforementioned means, etc. In another aspect, the aforementioned means may be a module, component, or any apparatus configured to perform the functions recited by the aforementioned means. Examples of such modules, components, or apparatus may be described with respect to FIG. 6.

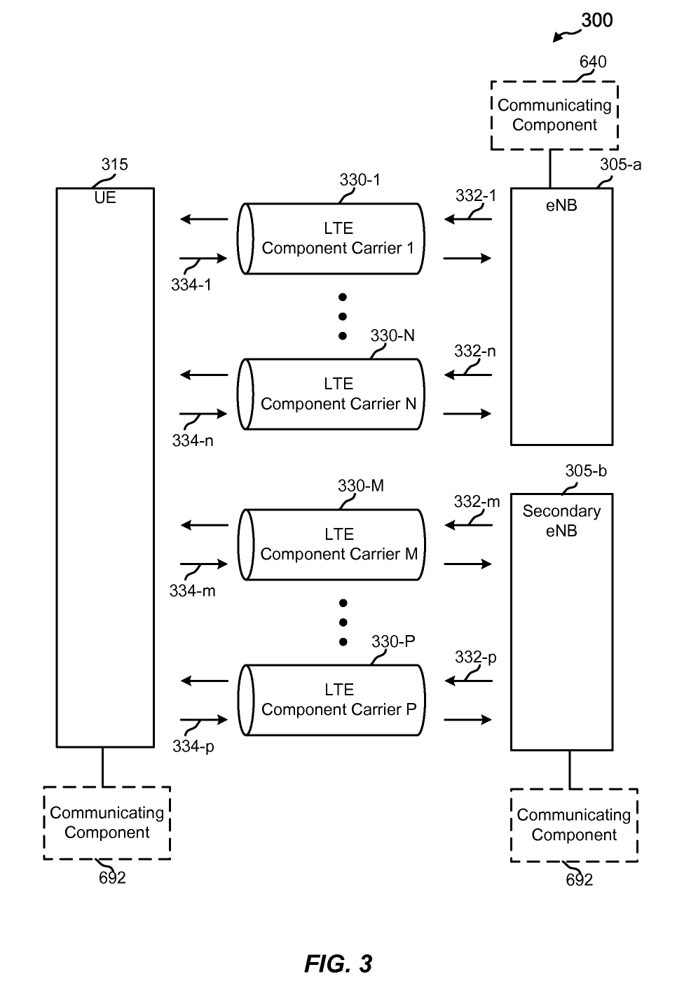

FIG. 3 is a block diagram conceptually illustrating an aggregation of carriers and/or connections at a UE, in accordance with aspects described herein. The aggregation may occur in a system 300 including a multi-mode UE 315, which can communicate with an eNodeB 305-a using one or more component carriers 1 through N (CC₁-CC_{N}), and/or with a secondary eNB 305-b using one or more component carriers M through P (CC_{M}-CC_{P}). For example, the eNodeB 305-a and/or secondary eNB 305-b may include an AP, femto cell, pico cell, etc. eNodeB 305-a can include a communicating component 640, as described herein, for scheduling data transmissions to one or more UEs 315 over resources of one or more CCs such to ensure that at least a threshold bandwidth utilization is achieved over at least one of the CCs or the CC otherwise may not be utilized. In addition, UE 315 and/or secondary eNodeB 305-b may include a communicating component 692, as described herein, for determining a portion of resources of at least one CC related to transmissions for a fictitious UE identifier by eNodeB 305-a and performing one or more operations based on the portion of resources (e.g., canceling interference, performing channel estimation, etc.).

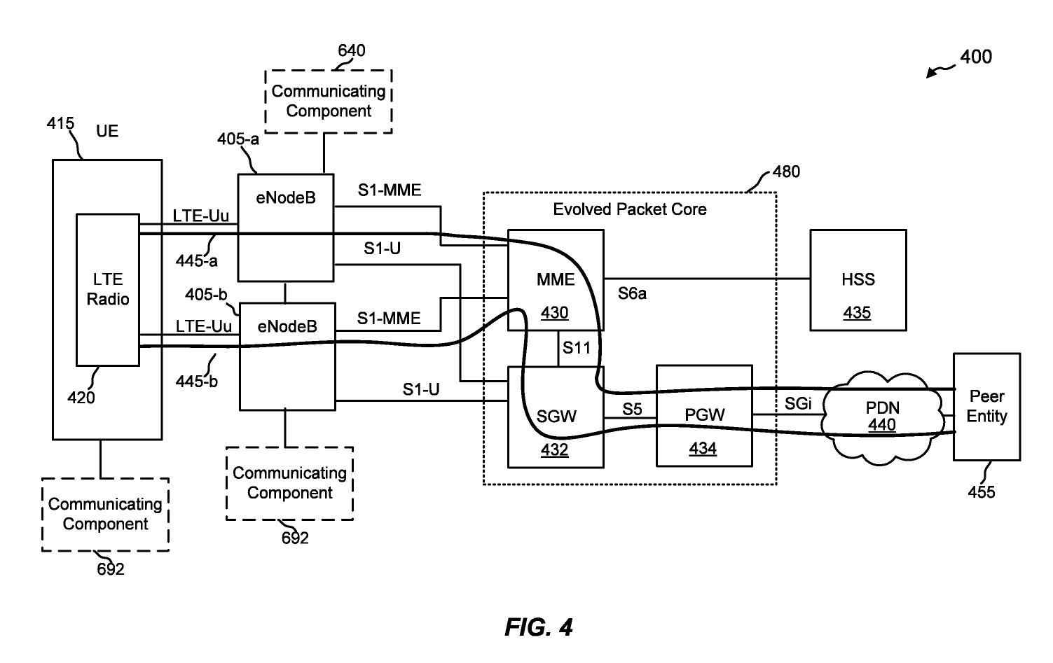

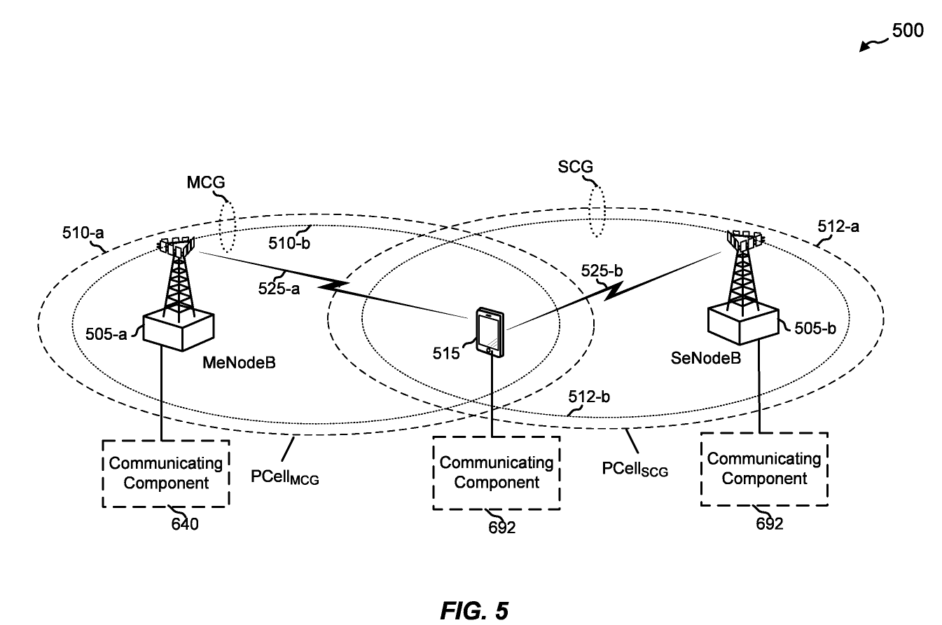

UE 315 may be a multi-mode UE in this example that supports more than one radio access technology (RAT). For example, the UE 315 may support at least a WWAN radio access technology (e.g., LTE) and/or a WLAN radio access technology (e.g., Wi-Fi). A multi-mode UE may also support carrier aggregation and/or multiple connectivity carrier aggregation using one or more RATs, as described herein. The UE 315 may be an example of one of the UEs of FIG. 1, FIG. 2, FIG. 4, FIG. 5, FIG. 6. The eNodeB 305-a and/or secondary eNB 305-b may be an example of one of the eNodeBs or base stations of FIG. 1, FIG. 2, FIG. 4, FIG. 5, FIG. 6. While only one UE 315, one eNodeB 305-a, and one secondary eNB 305-b are illustrated in FIG. 3, it will be appreciated that the system 300 can include any number of UEs 315, eNodeBs 305-a, and/or secondary eNBs 305-b. In one example, UE 315 can communicate with one eNB 305-a over one or more LTE component carriers 330-1 to 330-N while communicating with another eNB 305-b over another one or more LTE component carriers 330-M to 330-P.

The eNodeB 305-a can transmit information to the UE 315 over forward (downlink) channels 332-1 through 332-N on LTE component carriers CC₁ through CC_{N} 330. In addition, the UE 315 can transmit information to the eNodeB 305-a over reverse (uplink) channels 334-1 through 334-N on LTE component carriers CC₁ through CC_{N}. Similarly, the eNodeB 305-b may transmit information to the UE 315 over forward (downlink) channels 332-m through 332-p on LTE component carriers CC_{M} through CC_{P} 330. In addition, the UE 315 may transmit information to the eNodeB 305-b over reverse (uplink) channels 334-m through 334-p on LTE component carriers CC_{M} through CC_{P} 330.

In describing the various entities of FIG. 3, as well as other figures associated with some of the disclosed embodiments, for the purposes of explanation, the nomenclature associated with a 3GPP LTE or LTE-A wireless network is used. However, it is to be appreciated that the system 300 can operate in other networks such as, but not limited to, an OFDMA wireless network, a CDMA network, a 3GPP2 CDMA2000 network and the like.

In multi-carrier operations, the downlink control information (DCI) messages associated with different UEs 315 can be carried on multiple component carriers. For example, the DCI on a PDCCH can be included on the same component carrier that is configured to be used by a UE 315 for physical downlink shared channel (PDSCH) transmissions (i.e., same-carrier signaling). Alternatively, or additionally, the DCI may be carried on a component carrier different from the target component carrier used for PDSCH transmissions (i.e., cross-carrier signaling). In some implementations, a carrier indicator field (CIF), which may be semi-statically enabled, may be included in some or all DCI formats to facilitate the transmission of PDCCH control signaling from a carrier other than the target carrier for PDSCH transmissions (cross-carrier signaling).

In the present example, the UE 315 may receive data from one eNodeB 305-a. However, users on a cell edge may experience high inter-cell interference which may limit the data rates. Multiflow allows UEs to receive data from two eNodeBs 305-a and 305-b concurrently. In some aspects, the two eNodeBs 305-a may be non-collocated and may be configured to support multiple connectivity carrier aggregation. Multiflow works by sending and receiving data from the two eNodeBs 305-a/305-b in two totally separate streams when a UE is in range of two cell towers in two adjacent cells at the same time (see FIG. 5 below). The UE talks to two eNodeB 305-a and/or 305-b simultaneously when the device is on the edge of either eNodeBs' reach. By scheduling two independent data streams to the mobile device from two different eNodeBs at the same time, multiflow exploits uneven loading in the wireless communication networks. This can improve the cell edge user experience while increasing network capacity. In one example, throughput data speeds for users at a cell edge may double. In some aspects, multiflow may also refer to the ability of a UE to communicate with a WWAN tower (e.g., cellular tower/base station) and a WLAN tower (e.g., AP) concurrently when the UE is within the reach of both towers. In such cases, the towers may be configured to support carrier aggregation through multiple connections when the towers are not collocated.

FIG. 4 is a block diagram conceptually illustrating an example of data paths 445-a and 445-b between the UE 415 and the EPC 480 in accordance with an aspect of the present disclosure. The data paths 445-a, 445-b are shown within the context of a wireless communications system 400 for aggregating data over multiple CCs for transmitting using multiple eNodeBs 405-a, 405-b. The system 200 of FIG. 2 may be an example of portions of the wireless communications system 400. eNodeB 405-a can include a communicating component 640, as described herein, for scheduling data transmissions to one or more UEs 415 over resources of one or more CCs such to ensure that at least a threshold bandwidth utilization is achieved over at least one of the CCs or the CC otherwise may not be utilized. In addition, UE 415 and/or eNodeB 405-b may include a communicating component 692, as described herein, for determining a portion of resources of at least one CC related to transmissions for a fictitious UE identifier by eNodeB 405-a and performing one or more operations based on the portion of resources (e.g., canceling interference, performing channel estimation, etc.).

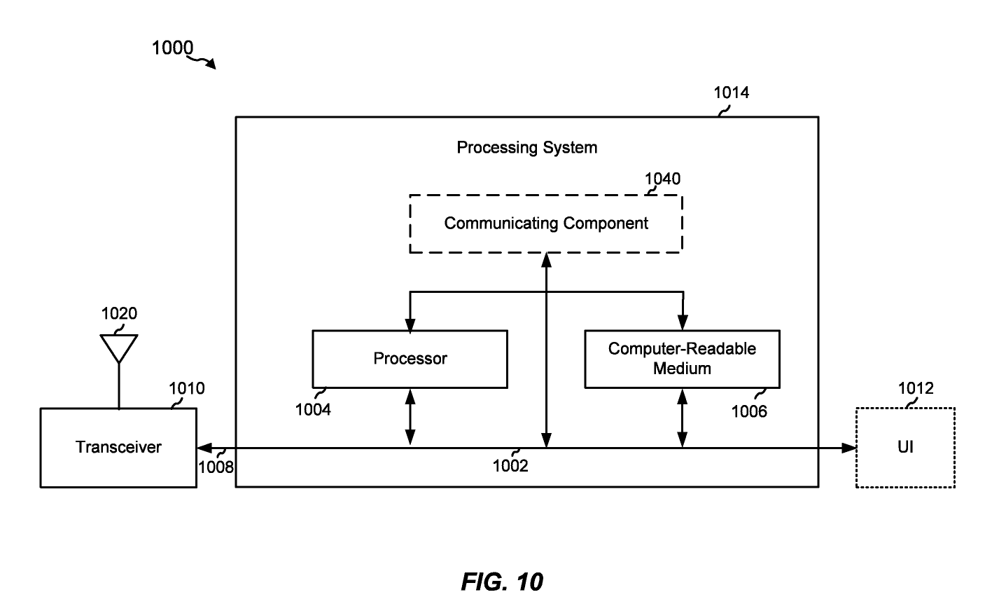

The wireless communications system 400 may include a UE 415, eNodeB 405-a, eNodeB 405-b, an evolved packet core (EPC) 480, a PDN 440, and a peer entity 455. The UE 415 may be configured to support carrier aggregation. The EPC 480 may include a mobility management entity (MME) 430, a serving gateway (SGW) 432, and a PDN gateway (PGW) 434. A home subscriber system (HSS) 435 may be communicatively coupled with the MME 430. The UE 415 may include an LTE radio 420. These elements may represent aspects of one or more of their counterparts described above with reference to the previous or subsequent Figures. For example, the UE 415 may be an example of UEs in FIG. 1, FIG. 2, FIG. 3, FIG. 5, FIG. 6, the eNodeB 405-a may be an example of the eNodeBs/base stations of FIG. 1, FIG. 2, FIG. 3, FIG. 5, FIG. 6, and/or the EPC 480 may be an example of the core network of FIG. 1 and/or FIG. 10. The eNodeB 405-a and eNodeB 405-b in FIG. 4 may or may not be collocated.

Referring back to FIG. 4, the eNodeB 405-a and the eNodeB 405-b may be capable of providing the UE 415 with access to the PDN 440 over separate uplink resource grants, which may relate to one or more LTE CCs, as described (e.g., a PCC and SCC). In addition, however, it is to be appreciated that eNodeB 405-a can provide one or more LTE CCs (e.g., a PCC and SCC) for the UE 415 in one or more cells. Accordingly, the UE 415 may involve carrier aggregation and/or dual connectivity, in this example, where one connection is to one network entity (eNodeB 405-a) and the other connection is to a different network entity (eNodeB 405-b), though it is to be appreciated that a single eNodeB may provide both CCs. Using this access to the PDN 440, the UE 415 may communicate with the peer entity 455. UE 415 can establish dedicated radio bearers that use connections with eNodeB 405-a or eNodeB 405-b to access the PDN 440 through the evolved packet core 480. Thus, for example, the eNodeBs 405-a and 405-b can communicate with one another to aggregate UE 415 communications for providing the EPC 480. In this example, UE 415 can access the PDN 440 to receive data over one or more bearers with the eNodeB 405-a or eNodeB 405-b.

The MME 430 may be the control node that processes the signaling between the UE 415 and the EPC 480, as described. Generally, the MME 430 may provide bearer and connection management for establishing and managing connectivity of the bearers. The MME 430 may, therefore, be responsible for idle mode UE tracking and paging, bearer activation and deactivation, and SGW selection for the UE 415. The MME 430 may communicate with the eNodeBs 405-a and 405-b over an S1-MME interface. The MME 430 may additionally authenticate the UE 415 and implement Non-Access Stratum (NAS) signaling with the UE 415, as described.

User IP packets transmitted over LTE may be transferred through eNodeB 405-a or eNodeB 405-b to the SGW 432, which may be connected to the PDN gateway 434 over an S5 signaling interface and the MME 430 over an S11 signaling interface. In one example, the MME 430 may also aggregate data received over the data paths 445-a and 445-b, and can provide the aggregated data on to the SGW 432 for further processing.

Thus, in the present example, user plane data between the UE 415 and the EPC 480 may traverse the bearers, which may be EPS bearers, over resources granted by one or more of the eNodeB 405-a and 405-b. Signaling or control plane data related to the set of one or more EPS bearers may be transmitted between the LTE radio 420 of the UE 415 and the MME 430 of the EPC 480, by way of the eNodeB 405-a or eNodeB 405-b, and may include eNodeB specific control plane data or bearer related control plane data.

While aspects of FIG. 4 have been described with respect to LTE, similar aspects regarding aggregation and/or multiple connections may also be implemented with respect to UMTS or other similar system or network wireless communications radio technologies.

FIG. 5 is a diagram conceptually illustrating multiple connectivity carrier aggregation in accordance with an aspect of the present disclosure. A wireless communications system 500 may include a master eNodeB 505-a (MeNodeB or MeNB) having a set or group of cells referred to as a master cell group or MCG that may be configured to serve the UE 515. The MCG may include one primary cell (PCell_{MCG}) 510-a and one or more secondary cells 510-b (only one is shown). The wireless communications system 500 may also include a secondary eNodeB 505-b (SeNodeB or SeNB) having a set or group of cells referred to as a secondary cell group or SCG that may be configured to serve the UE 515. The SCG may include one primary cell (PCell_{SCG}) 512-a and one or more secondary cells 512-b (only one is shown). Moreover, it is to be appreciated that more than one eNodeB can provide the cells in MCG and the cells in SCG. Also shown is a UE 515 that supports carrier aggregation for multiple connectivity (e.g., dual connectivity). The UE 515 may communicate with the MeNodeB 505-a, or a related PCell_{MCG}, via communication link 525-a and with the SeNodeB 505-b. or a related PCell_{SCG}, via communication link 525-b. eNodeB 505-a can include a communicating component 640, as described herein, for scheduling data transmissions to one or more UEs 515 over resources of one or more CCs such to ensure that at least a threshold bandwidth utilization is achieved over at least one of the CCs or the CC otherwise may not be utilized. In addition, UE 515 and/or eNodeB 505-b may include a communicating component 692, as described herein, for determining a portion of resources of at least one CC related to transmissions for a fictitious UE identifier by eNodeB 505-a and performing one or more operations based on the portion of resources (e.g., canceling interference, performing channel estimation, etc.).

In an example, the UE 515 may aggregate CCs from the same eNodeB or may aggregate CCs from collocated or non-collocated eNodeBs. In such an example, the various cells (e.g., different CCs) being used can be easily coordinated because they are either handled by the same eNodeB or by eNodeBs that can communicate control information. When the UE 515, as in the example of FIG. 5, performs carrier aggregation when in communication with two eNodeBs that are non-collocated, then the carrier aggregation operation may be different due to various network conditions. In this case, establishing a primary cell (PCell_{SCG}) in the secondary eNodeB 505-b may allow for appropriate configurations and controls to take place at the UE 515 even though the secondary eNodeB 505-b is non-collocated with the primary eNodeB 505-a.

In the example of FIG. 5, the carrier aggregation may involve certain functionalities by the PCell_{MCG} of the MeNodeB 505-a. For example, the PCell_{MCG} may handle certain functionalities such as physical uplink control channel (PUCCH), contention-based random access control channel (RACH), and semi-persistent scheduling to name a few. Carrier aggregation with dual or multiple connectivity to non-collocated eNodeBs may involve having to make some enhancements and/or modifications to the manner in which carrier aggregation is otherwise performed. Some of the enhancements and/or modifications may involve having the UE 515 connected to the MeNodeB 505-a and to the SeNodeB 505-b as described above. Other features may include, for example, having a timer adjustment group (TAG) comprise cells of one of the eNodeBs, having contention-based and contention-free random access (RA) allowed on the SeNodeB 505-b, separate discontinuous reception (DRX) procedures for the MeNodeB 505-a and to the SeNodeB 505-b, having the UE 515 send a buffer status report (BSR) to the eNodeB where the one or more bearers (e.g., eNodeB specific or split bearers) are served, as well as enabling one or more of power headroom report (PHR), power control, semi-persistent scheduling (SPS), and logical channel prioritization in connection with the PCell_{SCG} in the secondary eNodeB 505-b. The enhancements and/or modifications described above, and well as others provided in the disclosure, are intended for purposes of illustration and not of limitation.

For carrier aggregation in dual connectivity, different functionalities may be divided between the MeNodeB 505-a and the SeNodeB 505-b. For example, different functionalities may be statically divided between the MeNodeB 505-a and the SeNodeB 505-b or dynamically divided between the MeNodeB 505-a and the SeNodeB 505-b based on one or more network parameters. In an example, the MeNodeB 505-a may perform upper layer (e.g., above the media access control (MAC) layer) functionality via a PCell_{MCG}, such as but not limited to functionality with respect to initial configuration, security, system information, and/or radio link failure (RLF). As described in the example of FIG. 5, the PCell_{MCG} may be configured as one of the cells of the MeNodeB 505-a that belong to the MCG. The PCell_{MCG} may be configured to provide lower layer functionalities (e.g., MAC/PHY layer) within the MCG.

In an example, the SeNodeB 505-b may provide configuration information of lower layer functionalities (e.g., MAC/PHY layers) for the SCG. The configuration information may be provided by the PCell_{SCG} as one or more radio resource control (RRC) messages, for example. The PCell_{SCG} may be configured to have the lowest cell index (e.g., identifier or ID) among the cells in the SCG. For example, some of the functionalities performed by the SeNodeB 505-b via the PCell_{SCG} may include carrying the PUCCH, configuring the cells in the SCG to follow the DRX configuration of the PCell_{SCG}, configure resources for contention-based and contention-free random access on the SeNodeB 505-b, carrying downlink (DL) grants having transmit power control (TPC) commands for PUCCH, estimating pathloss based on PCell_{SCG} for other cells in the SCG, providing common search space for the SCG, and providing SPS configuration information for the UE 515.

In some aspects, the PCell_{MCG} may be configured to provide upper level functionalities to the UE 515 such as security, connection to a network, initial connection, and/or radio link failure, for example. The PCell_{MCG} may be configured to carry physical uplink control channel (PUCCH) for cells in the MCG, to include the lowest cell index among the MCG, to enable the MCG cells to have the same discontinuous reception (DRX) configuration, to configure random access resources for one or both of contention-based and contention-free random access on the MeNodeB 505-a, to enable downlink grants to convey transmit power control (TPC) commands for PUCCH, to enable pathloss estimation for cells in the MCG, to configure common search space for the MeNodeB 505-a, and/or to configure semi-persistent scheduling.

In some aspects, the PCell_{SCG} may be configured to carry PUCCH for cells in the SCG, to include the lowest cell index among the SCG, to enable the SCG cells to have the same DRX configuration, to configure random access resources for one or both of contention-based and contention-free random access on the SeNodeB 505-b, to enable downlink grants to convey TPC commands for PUCCH, to enable pathloss estimation for cells in the SCG, to configure common search space for the SeNodeB 505-b, and/or to configure semi-persistent scheduling.

Returning to the example of FIG. 5, the UE 515 may support parallel PUCCH and physical uplink shared channel (PUSCH) configurations for the MeNodeB 505-a and the SeNodeB 505-b. In some cases, the UE 515 may use a configuration (e.g., UE 515 based) that may be applicable to both carrier groups. These PUCCH/PUSCH configurations may be provided through RRC messages, for example.

The UE 515 may also support parallel configuration for simultaneous transmission of acknowledgement (ACK)/negative acknowledgement (NACK) and channel quality indicator (CQI) and for ACK/NACK/sounding reference signal (SRS) for the MeNodeB 505-a and the SeNodeB 505-b. In some cases, the UE 515 may use a configuration (e.g., UE based and/or MCG or SCG based) that may be applicable to both carrier groups. These configurations may be provided through RRC messages, for example.

FIG. 6 is a block diagram conceptually illustrating an example system 600 of an eNodeB 605-a, eNodeB 605-b, UE 615, and/or network node 690, and components configured in accordance with some aspects described herein. FIGS. 7-9, which are described in conjunction with FIG. 6 herein, illustrate example methods 700, 800, and 900 in accordance with aspects described herein. Although the operations described below in FIGS. 7-9 are presented in a particular order and/or as being performed by an example component, it should be understood that the ordering of the actions and the components performing the actions may be varied, depending on the implementation. Moreover, it should be understood that the following components, actions, and/or functions may be performed by a specially-programmed processor, a processor executing specially-programmed software or computer-readable media, or by any other combination of a hardware component and/or a software component capable of performing the described actions or functions.

Referring to FIG. 6, a system 600 is illustrated comprising an eNodeB 605-a that communicates with a UE 615 over a communication link 625-a including one or more CCs. System 600 can also include an eNodeB 605-b that communicates with the UE 615 over communication link 625-b including one or more additional CCs in carrier aggregation with communication link 625-a, which can be configured by eNodeB 605-a. In an example, communication link 625-a may include a PCC and/or one or more SCCs, and communication link 625-b may be an optional link including one or more SCCs in carrier aggregation. For example, the SCCs can utilize a frequency band subject to certain restrictions, such as a 5.8 GHz band that is subject to a required bandwidth utilization. In one example, one or more SCCs can be configured to use LTE in an unlicensed band (LTE-U) at 5.8 GHz or other frequency bands that may include one or more restrictions, such as a required bandwidth utilization.

eNodeB 605-a can configure UE 615 (and/or additional UEs) to utilize the PCC with eNodeB 05-a and one or more SCCs with eNodeB 605-a and/or 605-b, such to receive downlink communications over the PCC and SCC. In an example, eNodeB 605-a can also communicate with eNodeB 605-b over a backhaul link 634 to provide communications and/or scheduling information to the eNodeB 605-b for coordinating transmissions to the UE 615 (or multiple UEs) using the aggregated CCs. System 600 can also include a network node 690, which may be another UE communicating with at least eNodeB 605-a over communication link 691, which may be similar to communication link 625-a. In another example, network node 690 may be another eNodeB as well that communicates with eNodeB 605-a over a communication link 691 similar to backhaul link 634.

In an example, the eNodeB 605-a can implement a proportional fair scheduling for UEs, including UE 615, that jointly allocates resources for both PCC and SCC (e.g., except for certain control signaling). Communications for the UE(s) over the SCC, however, may not utilize enough bandwidth to achieve bandwidth utilization requirements for the frequency band of the SCC. eNodeB 605-a can accordingly determine whether to increase bandwidth over the SCC such to comply with the bandwidth utilization requirements or whether to restrict scheduling data such to relinquish the SCC where the bandwidth utilization requirements are not achieved.

In this regard, eNodeB 605-a can include a communicating component 640 for scheduling data transmissions to one or more UEs 115 over resources of one or more CCs such to ensure that at least a threshold bandwidth utilization is achieved over at least one of the CCs or the CC otherwise may not be utilized. Communicating component 640 can include a communication scheduling component 660 for scheduling resources for one or more UEs to receive communications from the eNodeB 605-a, and/or resources for the one or more UEs to utilize in transmitting communications to the eNodeB 605-a, and an optional UE identifier indicating component 680 for transmitting one or more signals indicating one or more fictitious UE identifiers used to schedule resources for communications from eNodeB 605-a over at least one CC such to achieve a level of bandwidth utilization. Communication scheduling component 660 may include a bandwidth utilization detecting component 662 for detecting whether the communication scheduling component 660 is scheduling communications over the at least one CC such to achieve a the bandwidth utilization, an optional bandwidth increasing component 664 for increasing the level of bandwidth utilization when it is determined that the communication scheduling component 660 is not scheduling communications such to achieve the level of bandwidth utilization over the CC, and/or an optional schedule restricting component 670 for restricting scheduling of resources over a CC where it is determined that the communication scheduling component 660 is not scheduling communications such to achieve the level of bandwidth utilization over the CC. Bandwidth increasing component 664 may optionally include a UE identifier assignment component 665 for assigning a fictitious UE identifier to receive scheduled data over the CC, a modulating component 667 for modulating data over resources for the fictitious UE identifier to facilitate cancelation of related signals, and/or an RB allocating component 669 for allocating one or more RBs over the CC for fictitious UE data transmission.

As described, network node 690 may be a UE, eNodeB, or other node that can receive communications and/or interference from eNodeB 605-a. Network node 690 may include a communicating component 692 for canceling interference caused by eNodeB 605-a transmitting one or more data signals, performing channel estimation based on determining resources related to fictitious UE identifiers, etc. For example, the interference may be caused by transmissions by the eNodeB 605-a using one or more fictitious UE identifiers to increase a bandwidth utilization. Communicating component 692 may optionally include a UE identifier determining component 694 for determining one or more fictitious UE identifiers for which eNodeB 605-a is transmitting data to increase bandwidth utilization, and/or a resource determining component 696 for determining resources associated with data transmissions for the fictitious UE identifier to assist in canceling interference over the resources.

FIG. 7 illustrates an example method 700 for scheduling data over one or more of a plurality of CCs based on determining a level of bandwidth utilization of at least one of the plurality of CCs. Method 700 includes, at Block 702, receiving data for transmission over a plurality of CCs. Communicating component 640 can receive the data for transmission over the plurality of CCs. As described, eNodeB 605-a can configure the plurality of CCs (e.g., a PCC and/or one or more SCCs) with eNodeB 605-a and/or eNodeB 605-b for transmitting/receiving wireless network communications over the aggregated plurality of CCs. Receiving data for transmission at Block 702 can include obtaining the data from higher layers of the eNodeB 605-a, and communication scheduling component 660 can schedule the data over one or more CCs (e.g., for transmission by eNodeB 605-a and/or eNodeB 605-b), as described further herein.

Method 700 optionally includes, at Block 704, preparing an unrestricted schedule for data over the plurality of carriers and a restricted schedule for data over a portion of the plurality of carriers. Communication scheduling component 660 can generate the unrestricted schedule and the restricted schedule. For example, communication scheduling component 660 can generate the unrestricted schedule at least in part by scheduling data jointly over the PCC and the one or more SCCs configured by eNodeB 605-a for the UE 615. Furthermore, for example, the unrestricted schedule can use a PCC_FLOW_LIST and an SCC_FLOW_LIST for managing flow for scheduling on the PCC and SCC, respectively (e.g., to specify one or more dedicated radio bearers (DRB) having data for scheduling over the PCC and/or SCC, respectively). It is to be appreciated that the SCC_FLOW_LIST can include DRBs of UEs with an active SCell duplicated from the PCC_FLOW_LIST. In the unrestricted schedule, the PCC_FLOW_LIST and SCC_FLOW_LIST can be provided to communication scheduling component 660 by higher layers at the eNodeB 605-a, and the communication scheduling component 660 can schedule the flows on a downlink channel to the UE 615 (e.g., over communication links 625-a and/or 625-b). Communication scheduling component 660 can generate the restricted schedule at least in part by scheduling data such to refrain from utilizing one or more of the CCs (an SCC utilizing a frequency band subject to restrictions including bandwidth utilization). For example, communication scheduling component 660 can generate the restricted schedule such to ensure the SCC_FLOW_LIST is empty (e.g., and data for the DRBs in the SCC_FLOW_LIST is scheduled in the PCC_FLOW_LIST).

Method 700 also includes, at Block 706, computing a level of bandwidth utilization of at least one of the plurality of CCs. Bandwidth utilization detecting component 662 can compute the level of bandwidth utilization of at least one of the plurality of CCs (e.g., the SCC as scheduled for communicating to the UE 615 and/or additional UEs). It is to be appreciated that where the communication scheduling component 660 prepares the restricted schedule in addition to the unrestricted schedule, the level of utilization can be computed based on resource block utilization for the SCC in the unrestricted schedule. In this regard, bandwidth utilization detecting component 662 can compute the level of utilization as a number of resource blocks assigned to the UE 615, and/or additional actual UEs, divided by a total number of resource blocks for the frequency band of the CC (e.g., 100 RBs for a 20 MHz CC in LTE).

Method 700 further includes, at Block 708, determining whether the level of bandwidth utilization is less than a threshold. Bandwidth utilization detecting component 662 can determine whether the computed level of utilization is less than a threshold. For example, the threshold can be configured based on a bandwidth utilization restriction of a frequency band utilized by the CC. In another example, the threshold can be configured to indicate whether bandwidth utilization of the SCC would be inefficient (e.g., require too much overhead or cause too much interference in filling the bandwidth according to bandwidth utilization requirements, etc.). It is to be appreciated that the threshold can be at least one of obtained by the bandwidth utilization detecting component 662 in a provisioning or network configuration from other network components (e.g., components of a core network 130), determined based on observations of historical thresholds and a level of overhead and/or interference caused to the system, and/or the like. In yet another example, bandwidth utilization detecting component 662 can adjust the threshold based at least in part on determining bandwidth utilization of the SCC in using the unrestricted or restricted scheduling, and determining whether the bandwidth utilization complies with the restriction when using the unrestricted scheduling or is greater than the threshold. For example, where bandwidth utilization detecting component 662 detects that the bandwidth utilization when using the unrestricted scheduling is less than the threshold (e.g., or at least a threshold difference from the threshold), bandwidth utilization detecting component 662 can increase the threshold for a subsequent resource scheduling. Similarly, where bandwidth utilization detecting component 662 detects that the bandwidth utilization when using the unrestricted scheduling is greater than the threshold (e.g., or at least a threshold difference from the threshold), bandwidth utilization detecting component 662 can decrease the threshold for a subsequent resource scheduling.

In any case, if the level of utilization is less than the threshold at Block 708, then method 700 includes, at Block 710, restricting scheduling over the at least one of the CCs. For example, schedule restricting component 670 can restrict scheduling over the at least one of the CCs. For example, where communication scheduling component 660 generates a restricted schedule, as described above, schedule restricting component 670 can utilize the restricted schedule in scheduling data over a portion of the plurality of CCs (e.g., such that data is not scheduled over the SCC). It is to be appreciated that this can include rescheduling the data where the communication scheduling component 660 already negotiated the PDCCH scheduler for PCC/SCC resources in generating the unrestricted schedule.

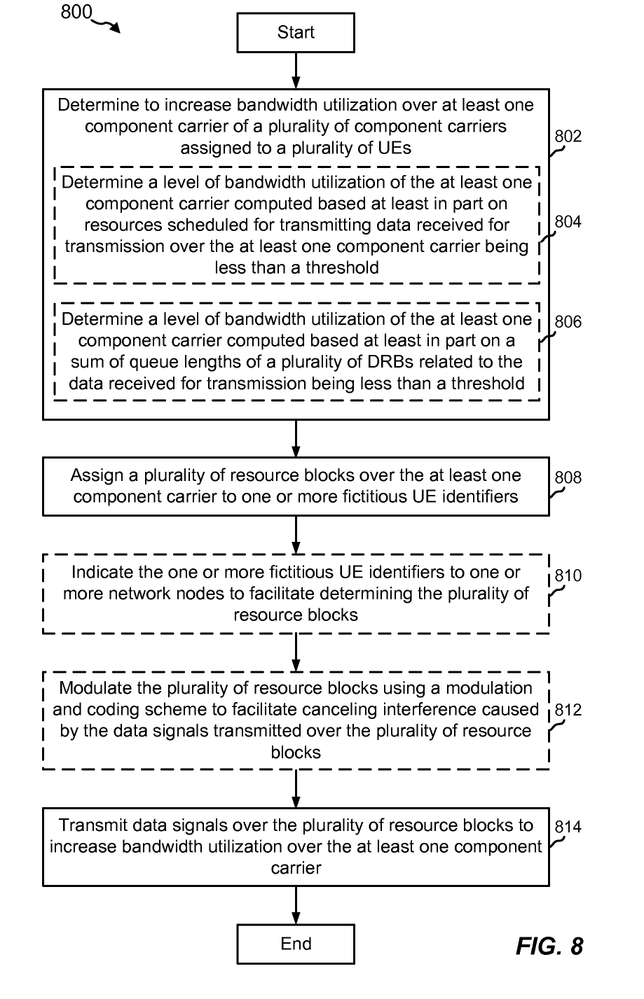

If the level of utilization is less than the threshold at Block 708, then method 700 can include, at Block 712, scheduling data over the plurality of CCs, and increasing bandwidth over at least one of the plurality of CCs to comply with one or more restrictions. For example, communication scheduling component 660 can schedule data over the plurality of CCs, and bandwidth increasing component 664 can increase bandwidth over at least one of the plurality of CCs (e.g., the SCC) to comply with the one or more restrictions. As described, the restrictions may relate to a required bandwidth utilization. In an example, described further in connection with FIG. 8, bandwidth increasing component 664 optionally includes a UE identifier assignment component 665 for assigning fictitious C-RNTIs to unassigned resource blocks over the SCC such to achieve the required bandwidth utilization. In another example, modulating component 667 can modulate the data using a lower MCS than an MCS initially selected for the data such to utilize a larger bandwidth (e.g., achieving bandwidth utilization requirements for the frequency band) in scheduling the data. In yet another example, RB allocating component 669 can spread out the resource block allocation to occupy a larger portion of the bandwidth such to satisfy a bandwidth utilization requirement. It is to be appreciated, in this example, that communicating component 640 can also increase a transmit power spectral density over a downlink shared channel to ensure the transmit power over the increased bandwidth is equal to a maximum transmit power.

In any case, method 700 also includes, at Block 714, transmitting data over at least a portion of the plurality of carriers. Thus, communicating component 640 can transmit the data over the PCC and/or SCC according to the unrestricted schedule with increased bandwidth or according to the restricted schedule, depending on the determination at Block 708. In this regard, bandwidth utilization requirements for the SCC can be achieved, or the data is scheduled such that the SCC is not utilized where bandwidth utilization requirements are not achieved.

In the above example, the level of bandwidth utilization is computed, at Block 706, based on the determined unrestricted schedule, and thus may result in multiple scheduling of data (e.g., where the restricted schedule is generated and used after the unrestricted schedule is generated). Thus, in another example, a heuristic approach of restricting the SCC can be utilized based on a queue length of one or more DRBs for downlink communications to the UE 615 and/or one or more other UEs. For example, DATA_QUEUE_LEN can denote the sum total of the queue lengths, in bytes, of the number of data bytes for the one or more DRBs at the beginning of time transmit interval (TTI) to be scheduled. In this example, if DATA_QUEUE_LEN is less than a threshold, the restricted schedule can be used such that the SCC is not utilized in scheduling data for communicating to the UE 615 and/or other UEs. In this example, however, the unrestricted and/or restricted scheduling may not need to be determined beforehand to compute the level of utilization, which can mitigate multiple scheduling of data as in the previous example.

Thus, in this example, computing the level of bandwidth utilization of at least one of the plurality of CCs at Block 706 can include computing the sum of queue lengths of one or more DRBs of one or more UEs. Thus, for example, bandwidth utilization detecting component 662 can compute the level of bandwidth utilization as DATA_QUEUE_LEN for the UE 615 and/or one or more additional UEs served by eNodeB 605-a and/or eNodeB 605-b. In this example, where the level of bandwidth utilization (DATA_QUEUE_LEN) is less than a queue length threshold, then at Block 710, scheduling is restricted over the at least one of the CCs. If the level of bandwidth utilization is not less than the queue length threshold, then at Block 712, data is scheduled over the plurality of CCs, and bandwidth is increased if necessary to comply with one or more restrictions of the frequency band utilized by the CC, as described above. Moreover, in either case, at Block 714, data is transmitted over at least a portion of the plurality of carriers based on the scheduling.

In an example, the queue length threshold can be a configurable parameter or a state that is learned dynamically by the bandwidth utilization detecting component 662 or other component in the system 600, as similarly described for the threshold in the previous example (e.g., based on observing historical values for the parameters and resulting overhead/interference in the system). For instance, bandwidth utilization detecting component 662 may implement a control loop for adjusting the threshold to target for lesser wasting of the resources. For example, bandwidth utilization detecting component 662 can operate the control loop to employ a control policy such as: if the actual bandwidth utilization (e.g., as determined once the data is scheduled over resources for transmission) is less than a utilization threshold, then the queue length threshold can be incremented by a delta value; and if the computed level of utilization is not less than the utilization threshold, then the queue length threshold can be decremented by another delta value. The delta values can be similarly configured or determined based on observations of historical parameters and resulting overhead/interference in the system.

FIG. 8 illustrates a method 800 for increasing bandwidth over one or more CCs, as described. Method 800 includes, at Block 802, determining to increase bandwidth over at least one CC of a plurality of CCs assigned to a plurality of UEs. As described, bandwidth increasing component 664 can determine to increase bandwidth over at least one CC of a plurality of CCs assigned to a plurality of UEs. For example, determining to increase the bandwidth utilization at Block 802 may optionally include, at Block 804, determining a level of bandwidth utilization of the at least one CC computed based at least in part on resources scheduled for transmitting data received for transmission over the at least one CC being less than a threshold. As described, for example, communication scheduling component 660 may receive data from higher layers for communicating with one or more UEs. Communication scheduling component 660 can schedule the data for transmitting to the one or more UEs over resources of the plurality of CCs. Where the scheduling results in bandwidth utilization that is below a required utilization specified for a frequency band of at least one of the CCs (e.g., where bandwidth increasing component 664 determines that ratio of a number of resource blocks over which data is scheduled for one or more UEs to a total number of resource blocks is less than a threshold), bandwidth increasing component 664 can determine to increase the bandwidth utilization over the at least one of the CCs.

Determining to increase the bandwidth utilization at Block 802 may also include, at Block 806, determining a level of bandwidth utilization of the at least one CC computed based at least in part on a sum of queue lengths of a plurality of DRBs related to the data received for transmission being less than a threshold. As described, for example, bandwidth increasing component 664 may determine the queue lengths prior to scheduling data for transmission over a plurality of resource blocks, such that adjustments in scheduling data (if needed) can be performed during an initial scheduling of data (e.g., as opposed to renegotiating data resources once it is determined to increase the bandwidth utilization).

Method 800 also includes, at Block 808, assigning a plurality of resource blocks over the at least one CC to one or more fictitious UE identifiers. UE identifier assignment component 665 can assign a plurality of resource blocks over the at least one CC to one or more fictitious UE identifiers. For example, communication scheduling component 660 can indicate scheduling of resources blocks to the one or more fictitious UE identifiers (e.g., in downlink control channel—e.g., PDCCH—communications), and can schedule communications for the one or more fictitious UE identifiers to increase the bandwidth utilization. In an example, in this regard, the one or more fictitious UE identifiers can include fictitious C-RNTIs. For example, the fictitious C-RNTIs may be assigned to resources in such a way to facilitate cancelation by unintended receivers (e.g., one or more neighboring cells), improve channel estimation using demodulation reference signals (DM-RS), etc. For example, UE identifier assignment component 665 can generate the fictitious C-RNTIs as random strings that correspond to a format of C-RNTIs, defined strings that are indicative of C-RNTIs that do not exist, actual previously used C-RNTIs, and/or the like.

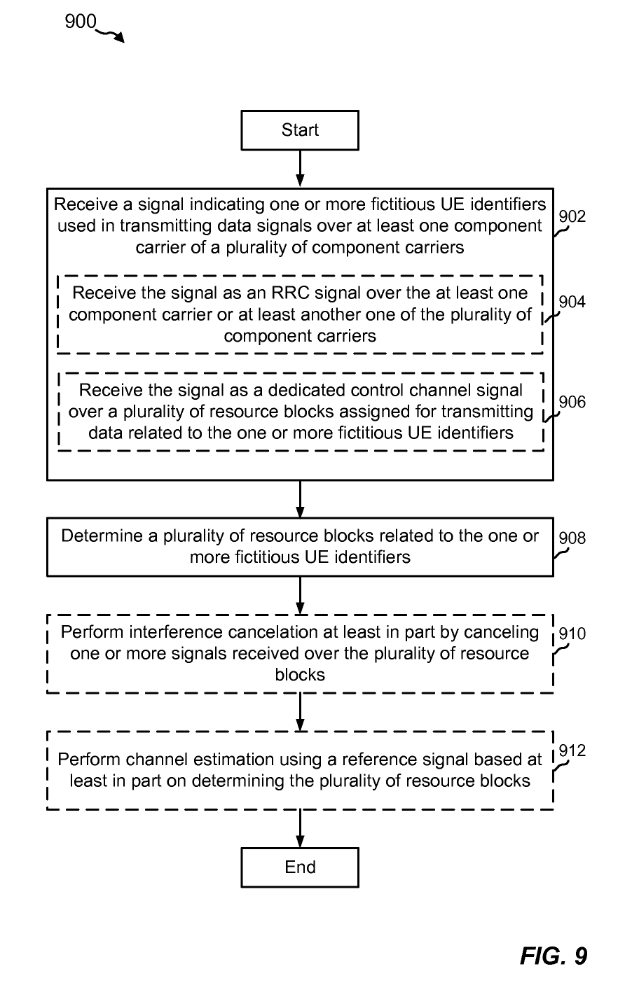

In an example, in this regard, method 800 may optionally include, at Block 810, indicating the one or more fictitious UE identifiers to one or more network nodes to facilitate determining the plurality of resource blocks. UE identifier indicating component 680 can indicate the one or more fictitious UE identifiers to the one or more network nodes (e.g., network node 690) to facilitate determining the plurality of resource blocks. Accordingly, as described in further detail below, the one or more network nodes may cancel interference caused by the data signals transmitted over the plurality of resource blocks, perform channel estimation based on DM-RS and based on determining the plurality of resource blocks, etc. For example, UE identifier indicating component 680 can signal the fictitious UE identifiers at layer 1 (L1)/layer 2 (L2) communications via PDCCH signaling or via higher layer signaling such as RRC signaling, etc. Thus, network node(s) 690 can receive the fictitious UE identifiers, and can utilize the signaled fictitious UE identifiers in locating resource blocks assigned to the fictitious UE identifiers for canceling interference over the resource blocks received from eNodeB 605-a over the SCC, performing channel estimation, etc., as described further in reference to FIG. 9. For example, UE identifier indicating component 680 can signal the fictitious UE identifiers over RRC signaling information on the PCC or SCC (e.g., via clear channel assessment (CCA) exempt transmissions (CET) over enhanced physical broadcast channel (ePBCH)/system information block (SIB), and/or the like). Thus, in one example, the fictitious UE identifiers related to the SCC may be signaled over the PCC. In another example, UE identifier indicating component 680 can signal the fictitious UE identifiers over dedicated PDCCH signaling that carries the data payload for the UE identifier. In any case, network node(s) 690 (e.g., one or more neighboring cells, UEs, etc.) can receive the UE identifiers and can locate PDCCH grants corresponding to the fictitious UE identifiers based on the received UE identifiers for canceling signals received over resources related to the PDCCH grants.

Moreover, in an example, to assist in canceling interference from signals received over resource blocks assigned to the fictitious UE identifiers, method 800 may optionally include, at Block 812, modulating the plurality of resource blocks using a MCS to facilitate canceling interference caused by the data signals transmitted over the plurality of resource blocks. For example, modulating component 667 may modulate the plurality of resource blocks using the MCS (e.g., quadrature phase shift keying (QPSK) or other low MCSs) to facilitate canceling the interference caused by the data signals transmitted over the plurality of resource blocks. In this regard, the network node(s) 690 can perform symbol level interference cancelation (SLIC) and/or codeword level interference cancelation (CWIC) based on the low MCS to cancel resource blocks assigned to the fictitious UE identifiers.

Method 800 also includes, at Block 814, transmitting data signals over the plurality of resource blocks to increase bandwidth utilization over the at least one CC. Communicating component 640 can transmit the data signals over the plurality of resource blocks to increase bandwidth utilization over the at least one CC. It is to be appreciated that data mapped over the resources assigned to the one or more fictitious UE identifiers may be randomly generated or may include other data that is not decoded by a UE (e.g., bits of all zeros or ones, etc.). Accordingly, as described, the UE 615 and/or network node(s) 690 (e.g., and/or eNodeB 605-b, etc.) can receive the signals for processing data corresponding to the UE 615, canceling interference caused by data transmitted for fictitious UE identifiers, performing channel estimation based on DM-RS, etc., as described.

FIG. 9 illustrates an example method 900 for determining resource blocks related to one or more fictitious UE identifiers. Method 900 includes, at Block 902, receiving a signal indicating one or more fictitious UE identifiers used in transmitting data signals over at least one CC of a plurality of CCs. UE identifier determining component 694 (FIG. 6) of a network node 690 receiving signals from an eNodeB 605-a can receive the signal indicating the one or more fictitious UE identifiers used in transmitting data signals over at least one CC of a plurality of CCs. As described, receiving the signal at Block 902 may include, at Block 904, receiving the signal as an RRC signal over at least one CC or at least another one of the plurality of CCs. Thus, for example, UE identifier determining component 694 may receive the signal over the CC (e.g., an SCC) or over another CC (e.g., a PCC though the fictitious UE identifiers indicated in the signal may relate to identifiers used in scheduling data over the SCC). In another example, receiving the signal at Block 902 may include, at Block 906, receiving the signal as a dedicated control channel signal (e.g., a PDCCH signal) over a plurality of resource blocks assigned for transmitting data related to the one or more fictitious UE identifiers. In this example, communicating component 692 can receive and decode the control channel signal, and UE identifier determining component 694 can determine the control channel signal is related to a fictitious UE identifier.

Method 900 also includes, at Block 908, determining a plurality of resource blocks related to the one or more fictitious UE identifiers. Resource determining component 696 can determine the plurality of resource blocks related to the one or more fictitious UE identifiers. For example, resource determining component 696 may determine resources assigned to the one or more fictitious UE identifiers based at least in part on an indication of assigned resources from a control channel. For example, the resources may relate to one or more resource blocks assigned to the one or more fictitious UE identifiers over a shared channel (e.g., a PDSCH) transmitted using the CC.

Method 900 may optionally include, at Block 910, performing interference cancelation at least in part by canceling one or more signals received over the plurality of resource blocks. For example, based on determining the plurality of resource blocks related to the fictitious UE identifier(s), communicating component 692 may cancel interference from signals received that relate to the plurality of resource blocks (e.g., by canceling the signals received over the indicated resource blocks).

In another example, method 900 may optionally include, at Block 912, performing channel estimation using a reference signal based at least in part on determining the plurality of resource blocks. Thus, communicating component 692 can perform channel estimation using the reference signal for a channel received from eNodeB 605-a, and the channel estimation may be improved based on the communicating component 692 knowing that the plurality of resource blocks relate to fictitious UE communications. For example, the resource blocks related to the one or more fictitious UE identifiers may also include reference tones (e.g., reference signals, such as cell-specific reference signals (CRS), DM-RS, etc.). Communicating component 692 can accordingly use the reference tones in the resource blocks to make wider band channel estimation for channels corresponding to the fictitious UE identifiers. Where communicating component 692 knows a precoding matrix of data for the network node 690 (e.g., as in the case of the CRS), communicating component 692 can apply the precoding matrix to the reference tones in the resource blocks to estimate the precoded channel. Where communicating component 692 does not know the precoding matrix (e.g., as in the case of the DM-RS), communicating component 692 can estimate the precoding matrix and apply the estimated precoding matrix to the reference tones in the resource block to augment channel estimation of the precoded channel.

FIG. 10 is a block diagram conceptually illustrating an example hardware implementation for an apparatus 1000 employing a processing system 1014 configured in accordance with an aspect of the present disclosure. The processing system 1014 includes a communicating component 1040. In one example, the apparatus 1000 may be the same or similar, or may be included with one of the UEs described in various Figures. In such example, the communicating component 1040 may correspond to, for example, which may be a communicating component 640 or communicating component 692, etc., as described herein. In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 links together various circuits including one or more processors (e.g., central processing units (CPUs), microcontrollers, application specific integrated circuits (ASICs), field programmable gate arrays (FPGAs)) represented generally by the processor 1004, and computer-readable media, represented generally by the computer-readable medium 1006. The bus 1002 may also link various other circuits such as timing sources, peripherals, voltage regulators, and power management circuits, which are well known in the art, and therefore, will not be described any further. A bus interface 1008 provides an interface between the bus 1002 and a transceiver 1010, which is connected to one or more antennas 1020 for receiving or transmitting signals. The transceiver 1010 and the one or more antennas 1020 provide a mechanism for communicating with various other apparatus over a transmission medium (e.g., over-the-air). Depending upon the nature of the apparatus, a user interface (UI) 1012 (e.g., keypad, display, speaker, microphone, joystick) may also be provided.

The processor 1004 is responsible for managing the bus 1002 and general processing, including the execution of software stored on the computer-readable medium 1006. The software, when executed by the processor 1004, causes the processing system 1014 to perform the various functions described herein for any particular apparatus (e.g., functions related to communicating component 640 and/or communicating component 692, functions related to methods 700, 800, 900, etc.). The computer-readable medium 1006 may also be used for storing data that is manipulated by the processor 1004 when executing software. The communicating component 1040, as described above, may be implemented in whole or in part by processor 1004, or by computer-readable medium 1006, or by any combination of processor 1004 and computer-readable medium 1006.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but it is to be accorded the widest scope consistent with the principles and novel features disclosed herein.

What is claimed is:

1. A method for scheduling data for transmission over a plurality of component carriers, comprising:
determining to increase a bandwidth utilization over at least one component carrier of a plurality of component carriers assigned to a plurality of user equipments (UE);
assigning a plurality of resource blocks over the at least one component carrier to one or more fictitious UE identifiers; and
transmitting data signals over the plurality of resource blocks to increase the bandwidth utilization over the at least one component carrier.

2. The method of claim 1, further comprising assigning a second plurality of resource blocks over the at least one component carrier for downlink transmission to the plurality of UEs based at least in part on a plurality of UE identifiers, wherein transmitting the data signals includes transmitting additional data signals over the second plurality of resource blocks to the plurality of UEs.

3. The method of claim 1, further comprising indicating the one or more fictitious UE identifiers to one or more network nodes to facilitate determining the plurality of resource blocks.

4. The method of claim 3, wherein indicating the one or more fictitious UE identifiers comprises transmitting the one or more fictitious UE identifiers in a radio resource control (RRC) signal over the at least one component carrier or another component carrier.

5. The method of claim 3, wherein indicating the one or more fictitious UE identifiers comprises transmitting the one or more fictitious UE identifiers in a dedicated control channel signal over the plurality of resource blocks related to the one or more fictitious UE identifiers.

6. The method of claim 1, further comprising modulating the plurality of resource blocks using a modulation and coding scheme to facilitate canceling interference caused by the data signals transmitted over the plurality of resource blocks.

7. The method of claim 1, wherein determining to increase the bandwidth utilization over the at least one component carrier comprises:
computing a level of the bandwidth utilization of the at least one component carrier based at least in part on data received for transmission over the at least one component carrier; and
determining that the level of the bandwidth utilization is less than a threshold.

8. The method of claim 7, wherein computing the level of the bandwidth utilization comprises computing a sum of queue lengths of a plurality of dedicated radio bearers related to the data received for transmission over the at least one component carrier.

9. The method of claim 8, further comprising adjusting the threshold based at least in part on determining an actual bandwidth utilization of the at least one component carrier after transmitting the data.

10. An apparatus for scheduling data for transmission over a plurality of component carriers, comprising:
a bandwidth increasing component configured to determine to increase a bandwidth utilization over at least one component carrier of a plurality of component carriers assigned to a plurality of user equipments (UE);
a communication scheduling component configured to assign a plurality of resource blocks over the at least one component carrier to one or more fictitious UE identifiers; and
a communicating component configured to transmit data signals over the plurality of resource blocks to increase the bandwidth utilization over the at least one component carrier.

11. The apparatus of claim 10, wherein the communication scheduling component is further configured to assign a second plurality of resource blocks over the at least one component carrier for downlink transmission to the plurality of UEs based at least in part on a plurality of UE identifiers, and wherein the communicating component is further configured to transmit additional data signals over the second plurality of resource blocks to the plurality of UEs.

12. The apparatus of claim 10, further comprising a UE identifier indicating component configured to indicate the one or more fictitious UE identifiers to one or more network nodes to facilitate determining the plurality of resource blocks.

13. The apparatus of claim 12, wherein the UE identifier indicating component is configured to indicate the one or more fictitious UE identifiers in a radio resource control (RRC) signal transmitted over the at least one component carrier or another component carrier.

14. The apparatus of claim 12, wherein the UE identifier indicating component is configured to indicate the one or more fictitious UE identifiers in a dedicated control channel signal transmitted over the plurality of resource blocks related to the one or more fictitious UE identifiers.

15. The apparatus of claim 10, further comprising a modulating component configured to modulate the plurality of resource blocks using a modulation and coding scheme to facilitate canceling interference caused by the data signals transmitted over the plurality of resource blocks.

16. The apparatus of claim 10, wherein the bandwidth increasing component is configured to determine to increase the bandwidth utilization over the at least one component carrier at least in part by:
computing a level of the bandwidth utilization of the at least one component carrier based at least in part on data received for transmission over the at least one component carrier; and
determining that the level of the bandwidth utilization is less than a threshold.

17. The apparatus of claim 16, wherein the bandwidth increasing component is configured to compute the level of the bandwidth utilization at least in part by computing a sum of queue lengths of a plurality of dedicated radio bearers related to the data received for transmission over the at least one component carrier.

18. The apparatus of claim 17, wherein the bandwidth increasing component is further configured to adjust the threshold based at least in part on determining an actual bandwidth utilization of the at least one component carrier after transmitting the data.

19. An apparatus for scheduling data for transmission over a plurality of component carriers, comprising:
means for determining to increase a bandwidth utilization over at least one component carrier of a plurality of component carriers assigned to a plurality of user equipments (UE);
means for assigning a plurality of resource blocks over the at least one component carrier to one or more fictitious UE identifiers; and
means for transmitting data signals over the plurality of resource blocks to increase the bandwidth utilization over the at least one component carrier.

20. The apparatus of claim 19, wherein the means for assigning assigns a second plurality of resource blocks over the at least one component carrier for downlink transmission to the plurality of UEs based at least in part on a plurality of UE identifiers, and wherein the means for transmitting transmits additional data signals over the second plurality of resource blocks to the plurality of UEs.

21. The apparatus of claim 19, further comprising means for indicating the one or more fictitious UE identifiers to one or more network nodes to facilitate determining the plurality of resource blocks.

22. The apparatus of claim 21, wherein the means for indicating indicates the one or more fictitious UE identifiers in at least one of a radio resource control (RRC) signal transmitted over the at least one component carrier or another component carrier, or a dedicated control channel signal transmitted over the plurality of resource blocks related to the one or more fictitious UE identifiers.

23. The apparatus of claim 19, further comprising means for modulating the plurality of resource blocks using a modulation and coding scheme to facilitate canceling interference caused by the data signals transmitted over the plurality of resource blocks.

24. The apparatus of claim 19, wherein the means for determining determines to increase the bandwidth utilization over the at least one component carrier at least in part by:
computing a level of the bandwidth utilization of the at least one component carrier based at least in part on data received for transmission over the at least one component carrier; and
determining that the level of the bandwidth utilization is less than a threshold.

25. A computer-readable storage medium storing computer executable code for scheduling data for transmission over a plurality of component carriers, the code comprising:
code for determining to increase a bandwidth utilization over at least one component carrier of a plurality of component carriers assigned to a plurality of user equipments (UE);
code for assigning a plurality of resource blocks over the at least one component carrier to one or more fictitious UE identifiers; and
code for transmitting data signals over the plurality of resource blocks to increase the bandwidth utilization over the at least one component carrier.

26. The computer-readable storage medium of claim 25, wherein the code for assigning assigns a second plurality of resource blocks over the at least one component carrier for downlink transmission to the plurality of UEs based at least in part on a plurality of UE identifiers, and wherein the code for transmitting transmits additional data signals over the second plurality of resource blocks to the plurality of UEs.

27. The computer-readable storage medium of claim 25, further comprising code for indicating the one or more fictitious UE identifiers to one or more network nodes to facilitate determining the plurality of resource blocks.

28. The computer-readable storage medium of claim 27, wherein the code for indicating indicates the one or more fictitious UE identifiers in at least one of a radio resource control (RRC) signal transmitted over the at least one component carrier or another component carrier, or a dedicated control channel signal transmitted over the plurality of resource blocks related to the one or more fictitious UE identifiers.

29. The computer-readable storage medium of claim 25, further comprising code for modulating the plurality of resource blocks using a modulation and coding scheme to facilitate canceling interference caused by the data signals transmitted over the plurality of resource blocks.

30. The computer-readable storage medium of claim 25, wherein the code for determining determines to increase the bandwidth utilization over the at least one component carrier at least in part by:
computing a level of the bandwidth utilization of the at least one component carrier based at least in part on data received for transmission over the at least one component carrier; and
determining that the level of the bandwidth utilization is less than a threshold.
